(19) United States
(12) Patent Application Publication
(10) Pub. No.: US 2006/0260469 A1
(43) Pub. Date: Nov. 23, 2006

(54) High flow air filtration system

(75) Inventors: Stuart T. Miyagishima, Upland, CA (US); Shahriar Nick Niakan, Anaheim Hills, CA (US)

Correspondence Address: SHIMOKAJI & ASSOCIATES, P.C., 8911 Research Avenue, Irvine, CA, 92618, US

(73) Assignee: Advanced Flow Engineering, Inc., Corona, CA (US)

(21) Appl. No.: 11/131,810

(22) Filed: May 18, 2005

(51) Int. Cl. B01D 46/00

(52) U.S. Cl. 95/273; 55/385.3

(57) ABSTRACT

A high flow air filtration system comprises a filter element, a housing, a billet adapter, a radial seal device (ex. o-ring) and a tube. The filter element within the housing may be bolted to a vehicle chassis. One end of the billet adapter may be clamped to the filter element and the o-ring may couple the other end to the tube. The o-ring may form a “floating seal” between the tube and the billet adapter, allowing the tube to move relative to the billet adapter to compensate for movement of the engine relative to the chassis. The o-ring seal replaces the flexible hose/coupling, which reduces turbulence within the flow path to the engine. The billet adapter may include at least one angle for reducing the inner diameter of the billet adapter and further reducing turbulence within the flow path to the engine.

### BACKGROUND OF THE INVENTION

The present invention generally relates to air filtration systems and, more particularly, to high flow air filtration systems for combustion engines, such as vehicle engines.

Generally, a combustion engine ignites a fuel/air mixture, producing combustion gases, and then extracts energy from these gases. The air provided to the engine is usually filtered to remove dust particles and other environmental contaminants that can damage engine components.

Air filtering systems have included flattened, cylindrical and conical shaped filter elements in flow communication with the air intake of the engine. The filter elements have comprised paper filters, oil bath types, treated filament filters, mesh types, foams and others. Although these filtering systems can reduce the contaminants in the air, some filter elements may restrict the air flow into the engine, reducing engine output.

Engine output may be a function of the volume of air supplied to the engine. Filtering systems have been designed to provide increased air flow to the engine. These systems have included filter elements having improved shape and/or composition. Air flow and engine output have been increased using these systems, but further increases in engine output may be desired for some applications.

Systems that increase the supply of oxygen available for combustion have improved engine output. Because cold air may be denser than hot air, systems that reduce the temperature of the air flow through the filtering system have provided increased oxygen to the engine. Methods for reducing air flow temperature have included shielding the filter element from the heat produced by the engine and relocating the filter element away from the engine.

Systems have been described that position the filter element closer to a road surface, such as behind a vehicle fender. Although these systems may provide cooler air, installation may be difficult. For example, the installation of some systems requires the fender or other parts to be removed to position the filter element and/or require cutting or trimming for clearance. Additionally, because the filter element is positioned close to the road surface, water from the road may be sucked into the intake, damaging the engine.

Filtering systems have been described that position the filter element under the vehicle hood, away from the engine and away from the road. Filtered air from the filter element has been passed to the engine via an intake tube that is attached to the throttle body of the engine.

Other under hood systems have positioned the filter element within a housing that is attached to the vehicle chassis. In these systems, a flexible link between the engine and chassis must be provided to compensate for the movement of the engine relative to the chassis. Various flexible links have been described, such as flexible hoses. Unfortunately, these flexible links are usually pleated, which disrupts the air flow through the tube.

As can be seen, there is a need for improved air filtration systems. Air filtration systems that can be installed without requiring part removal, cutting or trimming are needed. Further, air filtration systems are needed wherein flow stream obstructions are minimized.

### SUMMARY OF THE INVENTION

In one aspect of the present invention, a system for an engine comprises a billet adapter coupled to a back end of a filter element, the billet adapter having a tube overlap portion; a tube positioned such that an upstream end portion is radially inward from the tube overlap portion; and a radial seal device between and in contact with the tube overlap portion and the upstream end portion.

In another aspect of the present invention, a system for an engine comprises an inverted-top cone filter; an adapter assembly clamped to a back end of the inverted-top cone filter; and a tube having an upstream portion and a downstream portion, the upstream portion slidably connected to the adapter assembly, the downstream portion coupled to a throttle body of the engine.

In still another aspect of the present invention, a system for a vehicle comprises a housing bolted to a chassis of the vehicle; a filter element positioned within a filter cavity of the housing; a billet adapter clamped to the filter element; a radial seal device positioned within a groove of the billet adapter; and a tube positioned such that an upstream portion of the tube is radially inward from and in contact with the radial seal device.

In another aspect of the present invention, an assembly for a vehicle comprises a billet adapter having an inlet opening at an upstream end and an outlet opening towards a downstream end, the billet adapter including a flow path extending from the inlet opening to the outlet opening, the upstream end coupled to a filter element of the vehicle; a radial seal device positioned within a groove of the billet adapter; and a tube in contact with the radial seal device such that the tube is slidably connected to the billet adapter.

In yet another aspect of the present invention, a system for a vehicle comprises a powder-coated steel housing bolted to a chassis of the vehicle; an inverted-top cone filter positioned within a filter cavity of the powder-coated steel housing; an aluminum billet adapter having an inlet opening at an upstream end and an outlet opening towards a downstream end, the aluminum billet adapter including a flow path extending from the inlet opening to the outlet opening, the aluminum billet adapter clamped to the inverted-top cone filter, the aluminum billet adapter including three angles such that an inner diameter towards the upstream end is greater than an inner diameter towards the downstream end, the aluminum billet adapter having a tube overlap portion and a tube stop; an o-ring positioned within a groove of the tube overlap portion; and a tube positioned such that an upstream portion of the tube is radially inward from and in contact with the o-ring, a downstream portion of the tube coupled to a throttle body of the vehicle.

In a further aspect of the present invention, a method of providing a supply of filtered air to a vehicle engine comprises the steps of passing a supply of air through a filter element to produce the supply of filtered air; passing the supply of filtered air through a flow path of an adapter assembly having at least one angle adapted to reduce turbulence within the flow path; passing the supply of filtered air from the adapter assembly to a tube slidably connected to the adapter assembly; and passing the supply of filtered air from the tube to a component of the engine.

These and other features, aspects and advantages of the present invention will become better understood with reference to the following drawings, description and claims.

### BRIEF DESCRIPTION OF THE DRAWINGS

FIG. 1 is a perspective view of a high flow air filtration system according to one embodiment of the present invention;

FIG. 2 is a perspective view of a partially disassembled high flow air filtration system according to one embodiment of the present invention;

FIG. 3 is a perspective view of a high flow air filtration system installation according to one embodiment of the present invention;

FIG. 4 is a partially cut away perspective view of an adapter assembly installed on a tube according to one embodiment of the present invention; and

FIG. 5 is a flow chart of a method of providing a supply of filtered air to a vehicle engine according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides high flow air filtration systems and methods for producing the same. Embodiments of the present invention may find beneficial use in many industries including automotive, aerospace, and electricity generation. Embodiments of the present invention may be beneficial in applications including automobiles, aircraft and ships. Embodiments of this invention may be useful in any air filtration application.

In one embodiment, the present invention provides a high flow air filtration system for a vehicle engine. The high flow air filtration system may comprise a filter element, a housing, an adapter assembly and a tube. The filter element may be positioned within the housing and the housing may be bolted to the vehicle chassis. One end of the adapter assembly may be clamped to the filter element and the other end may be coupled to the tube. The tube may be connected to the engine's throttle body. The adapter assembly may comprise an o-ring adapted to form a “floating seal” between the tube and the adapter assembly. This is unlike the prior art that clamps an adapter to a tube, providing no “floating seal”. The “floating seal” of the present invention may allow the tube to move relative to the adapter to compensate for movement of the engine relative to the vehicle chassis. Because the tube of the prior art is clamped to the adapter, movement of the tube relative to the adapter is not provided. In order to allow movement of the tube relative to the adapter/housing, a flexible connector must be added.

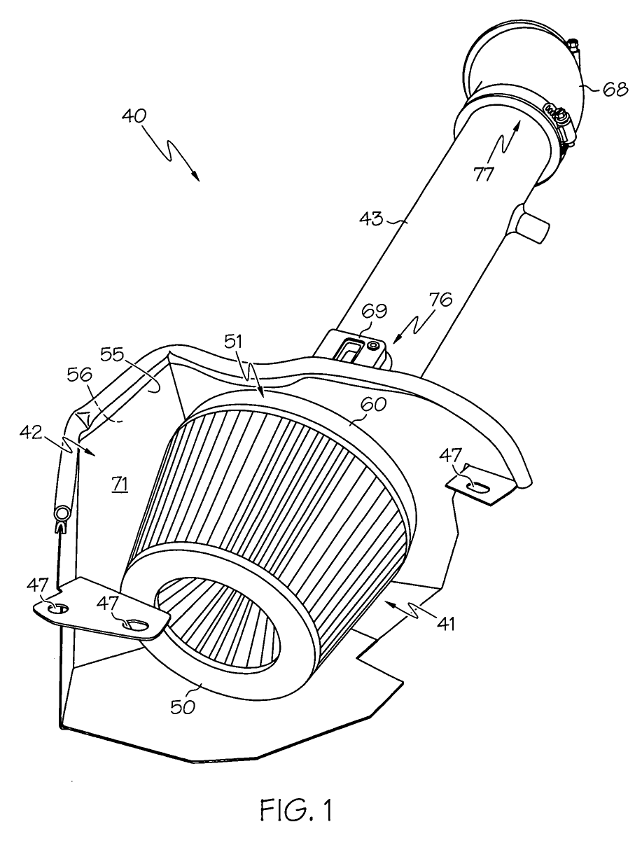

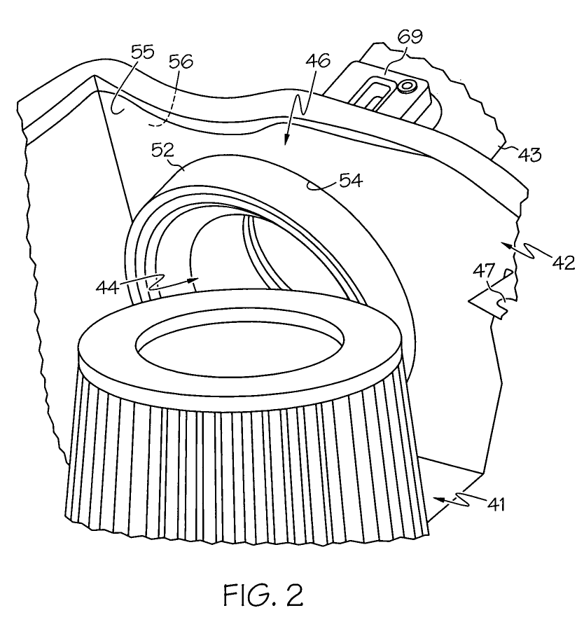

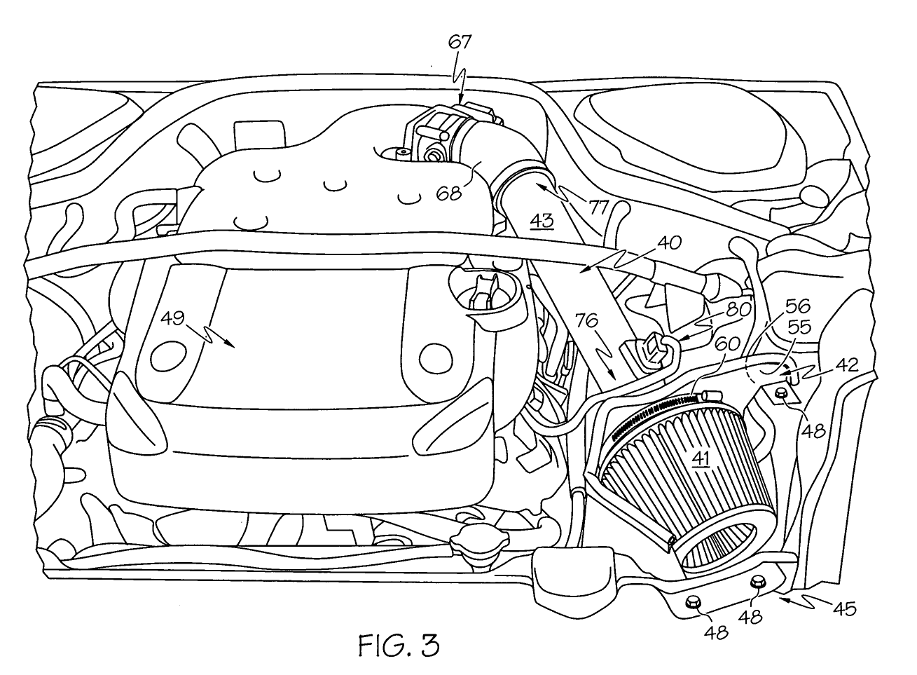

A high flow air filtration system 40 according to an embodiment of the present invention is shown in FIG. 1. The system 40 may comprise a filter element 41, a housing 42, an adapter assembly 44 (see FIG. 2) and a tube 43. The filter element 41 may be positioned within the housing 42, which may be bolted to a vehicle chassis 45 (see FIG. 3). The adapter assembly 44 may be positioned between and in contact with the filter element 41 and the tube 43, which may be clamped to a throttle body 67 of an engine 49 (see FIG. 3). The tube 43 may be slidably connected to the adapter assembly 44, allowing the tube 43 to move relative to the adapter assembly 44.

The filter element 41 may comprise any known filter element. The filter element 41 may comprise an inverted-top cone filter, as depicted. The filter element 41 may comprise materials, such as fibers and foams. The filter element 41 may comprise any known filter material, such as natural and synthetic fiber media. For some applications, the filter element 41 may comprise cotton and polyester pleated filter material. The filter element 41 may be washable and reusable. The filter element 41 may have a front end 50 and a back end 51, as depicted in FIG. 1. The back end 51 may be adapted to couple with an upstream end 52 (see FIG. 2) of the adapter assembly 44. The upstream end 52 may be defined with reference to the direction of air flow through the air filtration system 40. The filter element 41 may be positioned within a filter cavity 71 of the housing 42, as depicted in FIG. 1.

The housing 42 may comprise a structure adapted to provide the filter cavity 71 and to shield the filter element 41. The housing 42 may be positioned such that it may shield the filter element 41 from the heat produced by an engine 49, as depicted in FIG. 3. The housing 42 may comprise a structure having a first side 55 facing towards the filter element 41 and a second side 56 facing away from the filter element 41. The housing 42 may comprise materials including powder-coated steel, aluminum, plastic, and others. Any heat shielding material may be useful with the present invention. The shape and dimensions of the housing 42 may vary and may depend on factors including the dimensions of the filter element 41 and the application. The housing 42 may shield the filter element 41 from engine heat without restricting airflow into the filter element 41.

The housing 42 may comprise at least one bolt hole 47, as depicted in FIG. 1. The bolt holes 47 may be useful during the installation of the high flow air filtration system 40. The housing 42 may be attached to the vehicle chassis 45 by at least one bolt 48, as depicted in FIG. 3. For some applications, other attaching apparatus such as rivets (not shown), clamps (not shown), and screws (not shown) may be used in lieu of the bolts 48.

The housing 42 may include an adapter coupling portion 46, as depicted in FIG. 2. The adapter coupling portion 46 may comprise an opening 54 through which at least a portion of the adapter assembly 44 may be passed such that the upstream end 52 of the adapter assembly 44 is positioned within the filter cavity 71. The adapter coupling portion 46 may include at least one hole (not shown) for bolting the housing 42 to the adapter assembly 44.

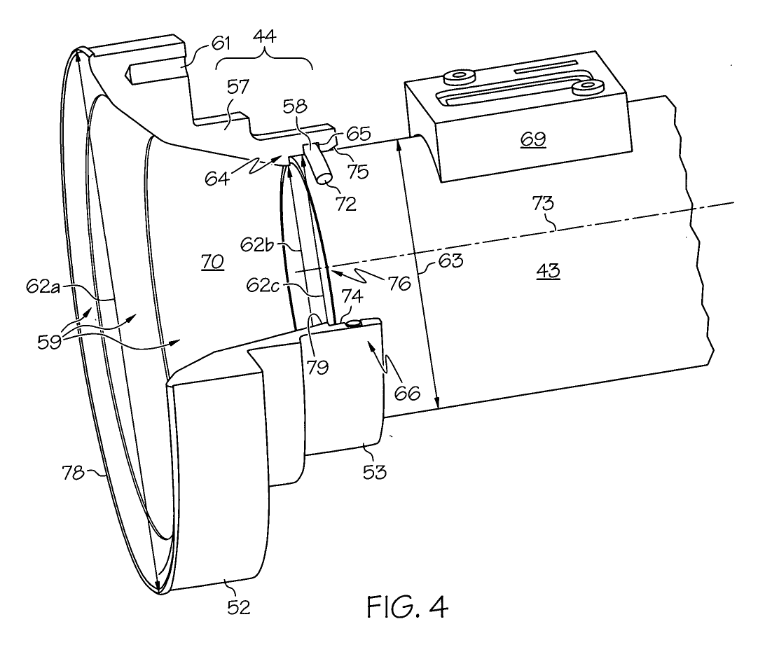

The adapter assembly 44 may comprise a billet adapter 57 and a radial seal device, such as an o-ring 58, as depicted in FIG. 4. The billet adapter 57 may include an inlet opening 78 at the upstream end 52 and an outlet opening 79 towards a downstream end 53. The billet adapter 57 may comprise a flow path 70 extending from the inlet opening 78 to the outlet opening 79. The flow path 70 may comprise a passage positioned between and in flow communication with the filter element 41 and the tube 43. The billet adapter 57 may comprise aluminum. For some application, the billet adapter 57 may comprise a plastic or other metals, such as steel.

The billet adapter 57 may have at least one bolt cavity 61 for bolting the billet adapter 57 to the housing 42. In other words, the adapter assembly 44 may be connected to the housing 42 by lining up the bolt cavities 61 with the holes (not shown) of the adapter coupling portion 46 and bolting the two components together.

The upstream end 52 of the billet adapter 57 may be designed to couple with the back end 51 of the filter element 41. The upstream end 52 of the billet adapter 57 may be connected to the back end 51 of the filter element 41 by a clamp 60 (see FIG. 3). For some applications, other attaching apparatus such as rivets (not shown), bolts (not shown), and screws (not shown) may be used in lieu of the clamp 60. The billet adapter 57 may be designed such that an inner diameter 62a towards the upstream end 52 is greater than an inner diameter 62b towards the downstream end 53, as depicted in FIG. 4.

The billet adapter 57 may include at least one angle 59 for reducing the inner diameter of the billet adapter 57. The number of angles 59 may vary and may depend on the inner diameter 62a towards the upstream end 52 and the inner diameter 62b towards the downstream end 53. For example, when the inner diameter 62a towards the upstream end 52 is about 5½ inches and the inner diameter 62b towards the downstream end 53 is about 3 inches, the billet adapter 57 may have three angles 59. The angles 59 may be positioned between the inlet opening 78 and the outlet opening 79 and may be adapted to reduce turbulence resulting from the difference in area between the inlet opening 78 and the outlet opening 79. The angles 59 may reduce turbulence within the flow path 70 to provide an aerodynamic flow path for the filtered air (not shown). Alternatively, the billet adapter 57 may have a radiused entry (not shown) in lieu of the angles 59 to provide the inner diameter reduction and aerodynamic flow path.

The billet adapter 57 may include a tube overlap portion 66, as depicted in FIG. 4. The tube overlap portion 66 may comprise an annular shaped structure extending downstream from the flow path 70. The tube overlap portion 66 may be positioned radially outward from a portion of the tube 43. An inner diameter 62c of the tube overlap portion 66 may be greater than an outer diameter 63 of the tube 43. For some applications, the radial clearance between the tube overlap portion 66 and the tube 43 may be between about 0.005 and about 0.010 inches. The radial clearance may be the distance between the tube overlap portion 66 and the tube 43.

The tube overlap portion 66 may include a groove 65. The groove 65 may be positioned on an inner diameter surface 74 of the tube overlap portion 66 and may be adapted to receive the radial seal device, such as the o-ring 58. The o-ring 58 may comprise any known o-ring material, such as an elastomer. For some applications, the o-ring 58 may comprise Buna N™, a synthetic rubber known in the art. The radial seal device may comprise the o-ring 58 and may comprise a round or circular cross-section. The radial seal device may also include other shapes to effect a seal, such as rectangular, wiper, etc. and may be spring loaded. The radial seal device may be positioned between and in contact with the tube overlap portion 66 and the tube 43, forming a seal 72 between the billet adapter 57 and the tube 43. The seal 72 may prevent contaminants, such as dust particles, from entering the flow path 70 at the interface between the tube 43 and the billet adapter 57. The seal 72 may comprise a “floating seal” and may allow for axial movement of the tube 43 to compensate for movement of the engine 49 relative to the vehicle chassis 45. Axial may be defined with reference to a longitudinal centerline 73 through the tube 43. In other words, the radial seal device may slidably connect the tube 43 to the billet adapter 57. For some applications, a lubricant (not shown), such as a silicone lubricant, may be positioned between the tube 43 and the tube overlap portion 66 for friction reduction. The tube overlap portion 66 may include a chamfer 75 for ease of installation of the tube 43.

The inner diameter 62c of the tube overlap portion 66 may be greater than the inner diameter 62b towards the downstream end of the flow path 70, forming a tube stop 64. The tube stop 64 may prevent axial movement of the tube 43 into the flow path 70. The tube stop 64 may provide an aerodynamic transition from the flow path 70 to the tube 43.

The tube 43 may comprise an upstream portion 76 positioned radially inward from the tube overlap portion 66 and in contact with the radial seal device, such as the o-ring 58, as depicted in FIG. 4. The tube 43 may comprise a downstream portion 77 coupled to the engine 49, as depicted in FIG. 3. The tube 43 may comprise a metal, such as steel or aluminum. The tube 43 may comprise other materials, such as a plastic. The tube 43 may be coupled to a component of the engine 49. For some applications the tube 43 may be coupled to an intake manifold (not shown) or an intake portion of a carburetor (not shown). For some applications, such as for a 2003 and up Nissan 350Z application, the tube 43 may be coupled to the throttle body 67. A connecting tube/clamp assembly 68, as depicted in FIG. 3, may couple the tube 43 to a component of the engine 49. The connecting tube/clamp assembly 68 may comprise any tube coupling apparatus, such as a length of flexible tubing and a pair of hose clamps.

Provisions may be made to retain the vehicle's mass air flow sensor 80 (MAF) (see FIG. 3). A mass air flow sensor pad 69 (MAF pad), as depicted in FIG. 4, may be operationally connected to the tube 43 and may provide a mounting surface for the MAF 80. MAFs 80 may be known in the art and may be used by the engine control unit (ECU) (not shown) to determine the amount of air entering the engine 49. The ECU may use the input from various sensors on the engine 49 to determine optimum spark advance and fuel delivery for the engine 49. For some applications, the MAF pad 69 may be welded to the tube 43.

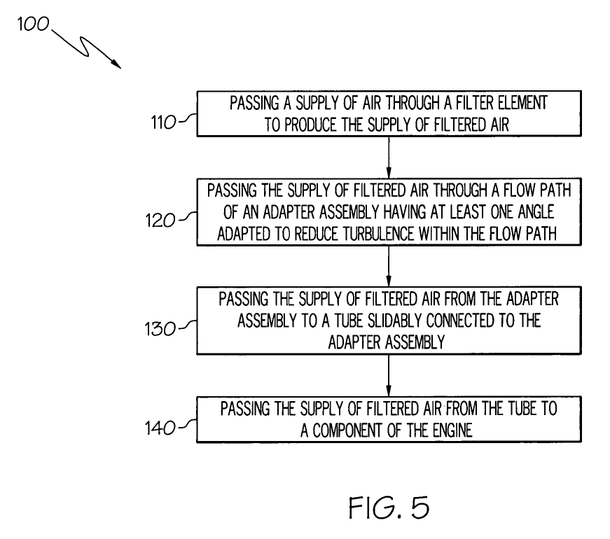

A method 100 of providing a supply of filtered air to a vehicle engine is depicted in FIG. 5. The method 100 may comprise a step 110 of passing a supply of air through a filter element to produce the supply of filtered air, a step 120 of passing the supply of filtered air through a flow path of an adapter assembly having at least one angle adapted to reduce turbulence within the flow path and a step 130 of passing the supply of filtered air from the adapter assembly to a tube slidably connected to the adapter assembly. The method may comprise a step 140 of passing the supply of filtered air from the tube to a component of the engine. The step 110 may comprise passing a supply of air through the pleated filter material of an inverted-top cone filter (e.g., filter element 41) bolted to the vehicle chassis 45. The adapter assembly 44 may be clamped to a back end 51 of the filter element 41 and the step 120 may comprise passing the filtered air from the backend 51 of the filter element 41 to the inlet opening 78 at the upstream end 52 of the adapter assembly 44. The step 120 may comprise passing the filtered air from the inlet opening 78, through the flow path 70, and towards the downstream end 53 of the adapter assembly 44. The angle 59 may be positioned between the inlet opening 78 and the outlet opening 79 to reduce turbulence due to the difference between an inner diameter 62a towards the upstream end 52 and an inner diameter 62b towards the downstream end 53. The step 130 may comprise passing the supply of filtered air to a throttle body 67 of the engine 49.

As can be appreciated by those skilled in the art, embodiments of the present invention provide improved high flow air filtration systems. The filtration systems according to embodiments of the present invention can be installed without removing the vehicle fender, can compensate for engine movement due to vehicle operation, and can provide a smooth, unobstructed path for the filtered air up to the engine's throttle body.

It should be understood, of course, that the foregoing relates to exemplary embodiments of the invention and that modifications may be made without departing from the spirit and scope of the invention as set forth in the following claims.

We claim:

1. A system for an engine comprising:
a billet adapter coupled to a back end of a filter element, said billet adapter having a tube overlap portion;
a tube positioned such that an upstream end portion is radially inward from said tube overlap portion; and
a radial seal device between and in contact with said tube overlap portion and said upstream end portion.

2. The system of claim 1, wherein said radial seal device comprises an o-ring.

3. The system of claim 1, wherein a lubricant is positioned between said tube overlap portion and said tube.

4. The system of claim 1, wherein said billet adapter comprises aluminum.

5. The system of claim 1, wherein an inner diameter of said billet adapter towards an upstream end is greater than an inner diameter of said billet adapter towards a downstream end.

6. The system of claim 1, wherein said billet adapter includes three angles.

7. The system of claim 1, wherein said tube overlap portion has a groove positioned on an inner diameter surface and adapted to receive said radial seal device.

8. The system of claim 1, wherein said billet adapter includes a tube stop.

9. The system of claim 1, wherein said tube is connected to a throttle body of said engine.

10. The system of claim 1, wherein said billet adapter has a radiused entry.

11. The system of claim 1, wherein a downstream portion of said tube is coupled to a throttle body of said engine.

12. A system for an engine comprising:
an inverted-top cone filter;
an adapter assembly clamped to a back end of said inverted-top cone filter; and
a tube having an upstream portion and a downstream portion, said upstream portion slidably connected to said adapter assembly, said downstream portion coupled to a throttle body of said engine.

13. The system of claim 12, wherein said adapter assembly comprises an aluminum billet adapter and a radial seal device.

14. The system of claim 13, wherein said radial seal device comprises an o-ring.

15. The system of claim 14, wherein said o-ring is positioned between and in contact with said tube and a tube overlap portion of said aluminum billet adapter.

16. The system of claim 15, wherein a radial clearance between said tube overlap portion and said tube is between about 0.005 and about 0.010 inches.

17. The system of claim 12, further comprising a housing positioned such that said housing shields said inverted-top cone filter from heat produced by said engine.

18. The system of claim 17, wherein said housing includes at least one hole for bolting said housing to said adapter assembly.

19. The system of claim 12, further comprising a mass airflow sensor pad operationally connected to said tube.

20. The system of claim 19, wherein said mass airflow sensor pad is welded to said tube.

21. The system of claim 12, wherein said tube comprises a metal.

22. A system for a vehicle comprising:
a housing bolted to a chassis of said vehicle;
a filter element positioned within a filter cavity of said housing;
a billet adapter clamped to said filter element;
a radial seal device positioned within a groove of said billet adapter; and
a tube positioned such that an upstream portion of said tube is radially inward from and in contact with said radial seal device.

23. The system of claim 22, wherein a downstream portion of said tube is coupled to a throttle body of said vehicle.

24. The system of claim 22, wherein said billet adapter comprises a plastic.

25. The system of claim 22, wherein said radial seal device comprises an o-ring.

26. The system of claim 22, wherein said billet adapter comprises aluminum.

27. An assembly for a vehicle comprising:
a billet adapter having an inlet opening at an upstream end and an outlet opening towards a downstream end, said billet adapter including a flow path extending from said inlet opening to said outlet opening, said upstream end coupled to a filter element of said vehicle;
a radial seal device positioned within a groove of said billet adapter; and
a tube in contact with said radial seal device such that said tube is slidably connected to said billet adapter.

28. The assembly of claim 27, wherein said billet adapter includes a chamfer.

29. The assembly of claim 27, wherein said billet adapter includes at least one angle.

30. The assembly of claim 27, wherein said billet adapter includes a tube stop.

31. The assembly of claim 27, wherein said radial seal device comprises an o-ring.

32. A system for a vehicle comprising:
a powder-coated steel housing bolted to a chassis of said vehicle;
an inverted-top cone filter positioned within a filter cavity of said powder-coated steel housing;
an aluminum billet adapter having an inlet opening at an upstream end and an outlet opening towards a downstream end, said aluminum billet adapter including a flow path extending from said inlet opening to said outlet opening, said aluminum billet adapter clamped to said inverted-top cone filter, said aluminum billet adapter including three angles such that an inner diameter towards said upstream end is greater than an inner diameter towards said downstream end, said aluminum billet adapter having a tube overlap portion and a tube stop;
an o-ring positioned within a groove of said tube overlap portion; and
a tube positioned such that an upstream portion of said tube is radially inward from and in contact with said o-ring, a downstream portion of said tube coupled to a throttle body of said vehicle.

33. A method of providing a supply of filtered air to a vehicle engine comprising the steps of:
passing a supply of air through a filter element to produce the supply of filtered air;
passing the supply of filtered air through a flow path of an adapter assembly having at least one angle adapted to reduce turbulence within the flow path;
passing the supply of filtered air from the adapter assembly to a tube slidably connected to the adapter assembly; and
passing the supply of filtered air from the tube to a component of the engine.

34. The method of claim 33, wherein said step of passing a supply of air through a filter element comprises passing a supply of air through the pleated filter material of an inverted-top cone filter within a housing bolted to the vehicle chassis.

35. The method of claim 33, wherein said step of passing the supply of filtered air through a flow path of an adapter assembly comprises passing the filtered air from an inlet opening of the adapter assembly to an outlet opening of the adapter assembly, the angle positioned between the inlet opening and the outlet opening.

36. The method of claim 33, wherein said step of passing the filtered flow from the tube to a component of the engine comprises passing the filtered flow to a throttle body of the engine.
